(19) United States
(12) Patent Application Publication
(10) Pub. No.: US 2013/0041913 A1
(43) Pub. Date: Feb. 14, 2013

(54) SYSTEMS AND METHODS FOR PROVIDING REAL TIME EMAIL CONTENT

(71) Applicants: Sastry VSM Durvasula, Phoenix, AZ (US); David M. Greenspan, Staten Island, NY (US); Sheree Newhouse, Phoenix, AZ (US); Courtney Sherwood, New York, NY (US); Sripriya V. Tiku, Scottsdale, AZ (US)

(72) Inventors: Sastry VSM Durvasula, Phoenix, AZ (US); David M. Greenspan, Staten Island, NY (US); Sheree Newhouse, Phoenix, AZ (US); Courtney Sherwood, New York, NY (US); Sripriya V. Tiku, Scottsdale, AZ (US)

(73) Assignee: American Express Travel Related Services Company, Inc., New York, NY (US)

(21) Appl. No.: 13/205,317

(22) Filed: Aug. 8, 2011

(51) Int. Cl. G06F 15/16; G06F 17/30

(52) U.S. Cl. 707/769; 709/206; 707/E17.014

(57) ABSTRACT

The present disclosure includes a system, method, and computer program product for serving real time email content to a client computer. The system may associate a consumer with a targeted market segment of consumers based upon a browsing history of the consumer and/or a purchasing history of the consumer. The system may further serve an email to the consumer based upon the association between the consumer and the targeted market segment of consumers—i.e., the system may serve an email to a consumer in the targeted market segment of consumers. The system may, in addition, serve the real time email content to the consumer in response to the consumer opening the email.

### BACKGROUND

1. Field

The present disclosure generally relates to electronic communications. More particularly, the disclosure relates to methods, systems, and computer readable mediums for providing real time email content.

2. Related Art

Item providers (“providers”) may market items (“items”) to a consumer through email. The consumer may include an individual, customer of the providers, entity, and the like. The providers may provide content, as described below, associated with the item as a static content and/or hyperlinks in the email. However, such content may be for a limited duration of time. The consumer may or may not read the emails comprising content while the content is still relevant (e.g., prior to the expiration of an offer, where the content comprises an offer). Such emails with expired content may cause inconvenience to the consumer. Also, in the past, it has not been possible for providers to update content provided in email after the email has been transmitted to a consumer. Furthermore, the consumer may not become aware of latest content until the providers provide a new or updated email with the latest content. As a result, the consumer may be deprived of the most recent and relevant content. Also, the providers may experience a decrease in their revenue as content may expire prior to redemption attempts by consumers.

Thus, there is a need for a method, system and/or program for providing offers as well as a variety of other content in real time through email.

### SUMMARY

The present disclosure includes a system, method, and computer program product for serving real time email content to a client computer. The system may associate a consumer with a targeted market segment of consumers based upon a browsing history of the consumer and/or a purchasing history of the consumer. The system may further serve an email to the consumer based upon the association between the consumer and the targeted market segment of consumers—i.e., the system may serve an email to a consumer in the targeted market segment of consumers. The system may, in addition, serve the real time email content to the consumer in response to the consumer opening the email.

The system may serve real time email content to a consumer based upon a query from an email client associated with the consumer, where the query may contain a unique image uniform resource locator (“URL”) and/or a unique hyperlink URL associated with the consumer. The unique image URL and/or the unique hyperlink URL may uniquely identify the consumer, and the system may use the unique image URL as a placeholder for real time email content that is served to the consumer. In other words, the system may replace the unique image URL with an image URL associated with real time email content. Likewise, the system may serve a hyperlink URL to the consumer, which may take the place of the unique hyperlink URL, and which may link the consumer to a webpage associated with the real time email content.

The system may further receive and serve updated real time email content. Updated real time email content may be served after serving the email to the consumer. Updated real time email content may further be served prior to a time that the consumer opens the email, and in addition to or instead of the real time email content.

Further features and advantages of the present disclosure as well as the structure and operation of various embodiments are described in detail below with reference to the accompanying drawings.

### BRIEF DESCRIPTION OF THE DRAWINGS

The features and advantages of the present disclosure will become more apparent from the detailed description set forth below when taken in conjunction with the drawings, in which like reference numbers indicate identical or functionally similar elements. Additionally, the left-most digit of a reference number identifies the drawing in which the reference number first appears.

FIG. 1 is an overview of an exemplary environment in which an content module for providing contents may be deployed, in accordance with various embodiments of the present disclosure;

FIG. 2 is an exemplary implementation of the content module for providing contents, according to an embodiment of the present disclosure;

FIG. 3 is an exemplary illustration illustrating a step of associating consumers to appropriate targeted market segments, according to an example embodiment of the present disclosure;

FIG. 4 is an exemplary illustration illustrating emails comprising a unique URL and/or a unique hyperlink URL associated with each consumers, according to an example embodiment of the present disclosure;

FIG. 5 is an exemplary illustration illustrating a step of receiving content data comprising offers from content provider, according to an example embodiment of the present disclosure;

FIG. 6 is an exemplary illustration illustrating a step of serving real time email content to the emails, according to an example embodiment of the present disclosure;

FIG. 7 is a flow chart illustrating one example process of communicating a real email time content to the consumer in response to consumer opening the email, according to an embodiment of the present disclosure; and

FIG. 8 is a block diagram of an exemplary computer system, according to an embodiment of the present disclosure.

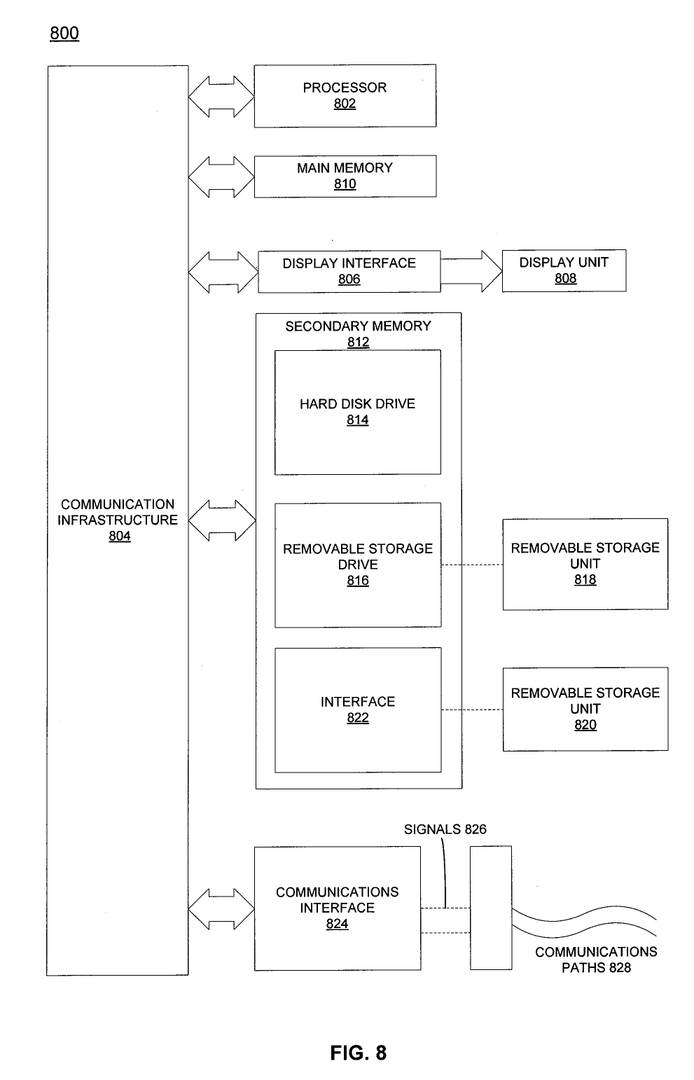

### DETAILED DESCRIPTION

The detailed description of exemplary embodiments herein makes reference to the accompanying drawings and pictures, which show the exemplary embodiment by way of illustration and its best mode. While these exemplary embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

A “content provider”, as used herein, may include any individual, business, entity, group, charity, software and/or hardware that desire to offer or market goods or services for sale. The content provider may be a item provider or a marketing agency that offers or markets goods or services for sale. For example, a content provider may be a restaurant or an advertisement agency associated with the restaurant that wishes to offer a discount to consumers about food and dining services through an email in a real time.

A “consumer”, as used herein, may include any individual, business, entity, group, charity, software and/or hardware that desires to utilize the system to obtain promotional items or purchase items from a merchant. It is noted that the terms “customer,” “consumer,” “user”, “individual,” and “population” are used interchangeably herein.

An “offer”, as used herein, may include any discounts, awards, gift card, items, rebate on any items provided by a merchant.

“Content,” as used herein, may comprise one or more offers, items and/or other information including advertisements, promotions, coupons, messages, notes, invitations, notifications, servicing information (e.g., the status of a fraud claim), and the like.

A “consumer identifier,” as used herein, may comprise an identifier associated with a consumer. For example, a consumer identifier may comprise a unique image URL, a unique hyperlink URL, a cookie, a pixel, a globally unique identifier (e.g., an American Express GUID), any combination of these, and the like. Moreover, a unique hyperlink URL, which may direct a consumer to a location, a place, a website, a phone number, a call to action, and the like, may be interchanged with any other device and/or method for performing the same function (e.g., a cookie, a pixel, a GUID, any combination of these, etc.) Similarly, a unique image URL, which may uniquely identify a consumer, may be interchanged with any other device and/or method for performing the same function (e.g., a cookie, a pixel, a GUID, any combination of these, etc.)

Phrases and terms similar to an “item” may include any good, service, information, experience, data, content, access, rental, lease, contribution, account, credit, debit, benefit, right, reward, points, coupons, credits, monetary equivalent, anything of value, something of minimal or no value, monetary value, non-monetary value and/or the like.

It is further noted that a “client device” may include, for example, any of computer, laptop, mobile phone, cellular telephones, beepers, pagers, iPods®, personal digital assistants (PDAs), Blackberry® type devices and/or any device capable of receiving and presenting emails.

In an embodiment, various components, modules, and/or engines of the system may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, the term “network” may include any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/groups/SNS/cloud-computing/cloud-def-v15.doc (last visited Feb. 4, 2011), which is hereby incorporated by reference in its entirety.

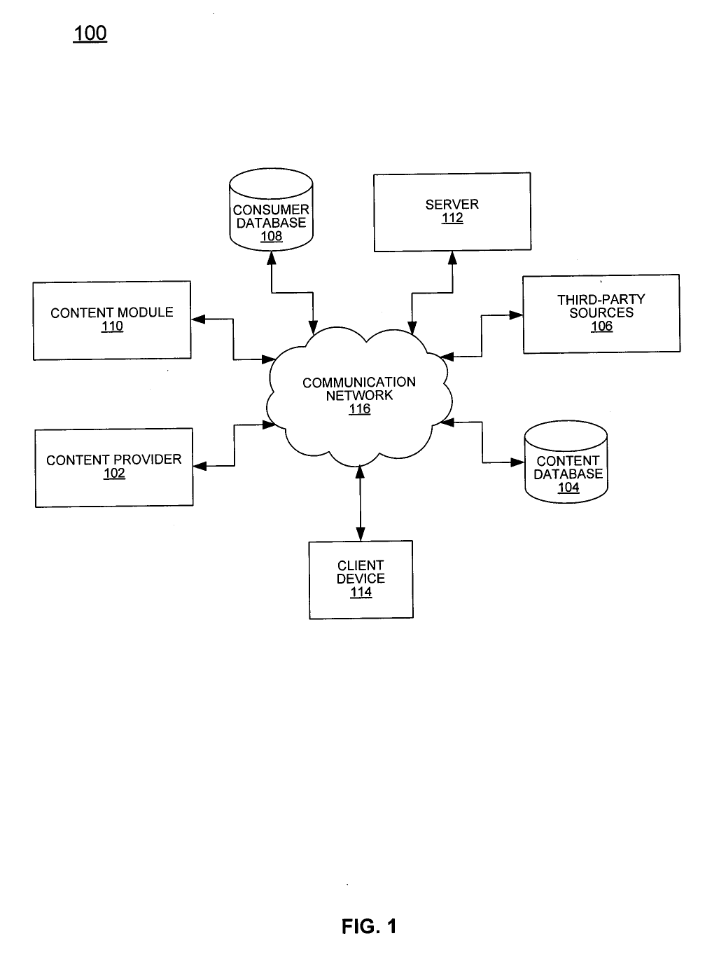

With reference to FIG. 1 an exemplary system 100 for providing real time email content is shown. System 100 may comprise a content provider 102, a content database 104, third-party sources 106, a consumer database 108, a content module 110, a server 112, a client device 114, and a communication network 116. Content provider 102, content database 104, third-party sources 106, consumer database 108, content module 110, server 112, and/or client device 114, may communicate with each other over communication network 116.

Content provider 102 may comprise any hardware, software and/or computer-based system for providing content. For example, content provider 102 may comprise one or more computer servers configured or configurable to provide content. Content provider 102 may facilitate input, receipt and/or review of information relating to one or more contents. Content provider 102 may provide content to content database 104. Further, although a single content provider 102 is shown, there may be more than one content provider.

Content database 104 may comprise any type of computer server configured or configurable to host a database. Typically, such a server comprises a rack mountable server appliance running a suitable server operating system (e.g., IIS) and having database software (e.g., Oracle) installed thereon.

Consumer database 108 may comprise a data processing system that stores and maintains information associated with one or more consumers. Consumer database 108 may be maintained by a service provider such as a transaction account issuer, a merchant, and/or a group of merchants. Consumer database 108 may provide consumer information to content module 110. Consumer information may include personal information such as, a name, an address, current geographical location, gender, age, other demographic information, contact details, such as e-mail address, phone number, correspondence address, social security number, and the like. Consumer information may also include consumer preferences, consumer shopping history, and the like. Further, although separate databases such as content database 104 and consumer database 108 are described herein, these databases may be implemented as a single database.

Third-party sources 106 may comprise one or more internet service providers, merchants from whom a consumer may have purchased, and/or online service providers (e.g., Google® Analytics, Urchin Software from Google® Inc., Yahoo!® Web Analytics, Omniture's® Site Catalyst and the like). Third-party sources 106 may provide browsing data, purchase history, data and/or consumer information to content module 110. Browsing data may include web surfing information, web browsing patterns, social networking information, searches relating to item, and the like. Third-party sources 106 may also provide transaction history of consumers, historical offers provided to consumers, record of offer acceptance from consumers, lifestyle information of consumers, one or more preferences of consumers, consumer shopping patterns, and the like. The browsing data, purchase history data and/or consumer information provided by third-party sources 106 may be used by content module 110 to identify and direct relevant contents to the consumer.

Content module 110 may comprise any hardware, software and/or computer-based system for serving content to consumers through email, SMS, MMS, an instant message, a pager message, and the like. Content module 110 may comprise a single server and/or a group of servers and/or be deployed on one or more servers. Content module 110 may comprise and/or be deployed on one or more servers associated with content provider 102, the transaction service provider and/or the issuer. Content module 110 may also comprise/be deployed on one or more third-party servers. Content module may 110 may further comprise an email server. Although providing real time email content is discussed in response to opening an email, it will be readily apparent to one skilled in the art that content module 110 may provide content to email regardless of a consumer action on the email.

Content module 110 may provide emails and/or content to consumers (e.g., through server 112). Content module 110 may receive data from consumer database 108 and/or third-party sources 106. Content module 110 may identify a targeted market segment relevant to the consumer based on the data received from consumer database 108 and/or third-party resources 106. For example, if a consumer is a frequent flier, then a frequent flier market segment may be identified for that consumer. Content module 110 may also serve an email to the consumer based on the identified targeted market segment. The email may include a consumer identifier (e.g., either or a combination of a unique image URL and/or a unique hyperlink URL), which may identify a consumer and/or the identified targeted market segment relevant to the consumer. Content module 110 may receive content, from content provider 102, including content (e.g., one or more offers) associated with various market segments and/or content that is unassociated with market segments but which may, nevertheless, be provided to consumers. Content module 110 may then associate the content received from content provider 102 with a consumer based on the identified targeted market segment relevant to the consumer and/or other criteria (e.g., demographic information, randomly, etc). In an exemplary embodiment, content module 110 may replace the content of the earlier email sent to the consumer with new or updated content associated with the targeted market segment. Content module 110 may serve the content, as real time email content, to a consumer in response to the consumer opening the earlier email. The content may include offers having offer periods that are relevant to the time of opening the email and later. Although the disclosure describes providing offers through email, offers may be provided through Short Message Service (SMS), Multimedia Message Service (MMS), a phone call, an instant message, a pager message, and the like, upon the consumer opening the email.

Server 112 may comprise any email server, group of email servers, and/or server or group of servers configured or configurable to serve email. Server 112 may comprise a stand alone server and/or a part of content module 110.

Client device 114 may comprise any device, as described above, capable of receiving emails. For example, client device 114 may comprise a data processing system such as a mobile device, any suitable personal computer, a laptop, minicomputer, Personal Digital Assistant (PDA), or the like. Client device 114 may comprise an operating system (e.g., Windows NT, 95/98/2000, OS2, UNIX, Linux, Solaris, MacOS, etc.) as well as various conventional support software and drivers typically associated with computer. Client device 114 may also include an internal memory, an external memory and a cache. Client device 114 may also include one or more browsers (e.g., Microsoft® Internet explorer, Mozilla® Firefox, etc.) through which an email server may be accessed. Alternatively, client device 114 may include a client email program such as a Microsoft® Outlook, Mozilla® Thunderbird, Pegasus® Mail, and the like, for downloading, reading, replying and/or forwarding the email. Although, a single client device 114 is illustrated herein for exemplary purposes, system 100 may comprise more than one client device 114.

Content database 104, consumer database 108 and/or one or more databases associated with content module 110 (not shown) may employ any type of database, such as relational, hierarchical, graphical, object-oriented, and/or other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, in one exemplary embodiment, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand alone device, the appropriate option for the action to be taken. The system may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O′Reilly & Associates (1998); (3) “Cryptography & Network Security: Principles & Practice” by William Stallings, published by Prentice Hall; all of which are hereby incorporated by reference. Encryption may be performed by way of any of the techniques now available in the art or which may become available—e.g., Twofish, RSA, El Gamal, Schorr signature, DSA, PGP, PKI, and symmetric and asymmetric cryptosystems.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

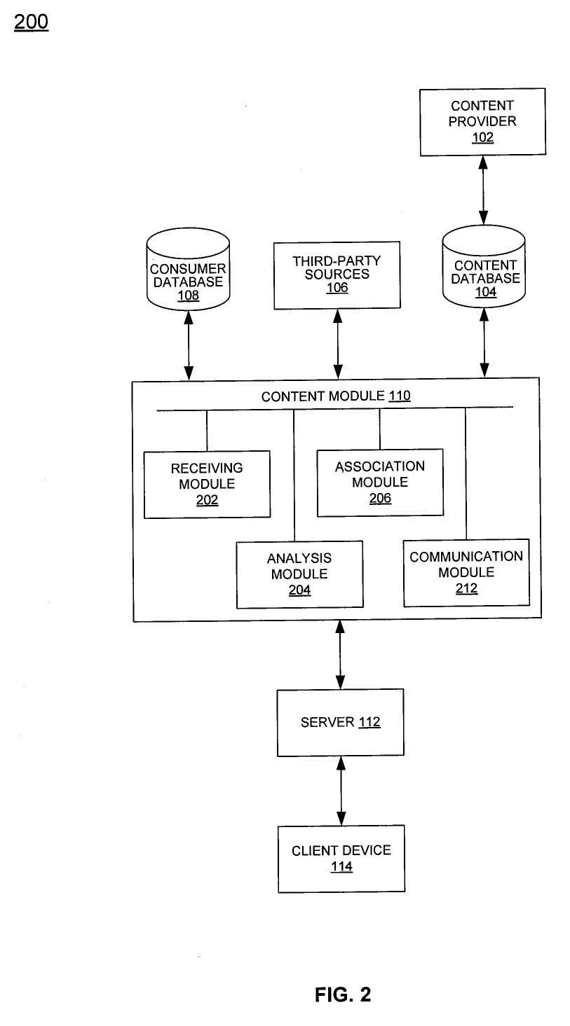

Referring to FIG. 2, an exemplary implementation of content module 110 is depicted, according to an embodiment of the disclosure. As illustrated in FIG. 2, content module 110 is communicatively coupled to content database 104, third-party sources 106, consumer database 108, and server 112. In one example implementation, content module 110 may include a receiving module 202, an analysis module 204, an association module 206, and a communication module 212. Content module 110 may further include a content management tool (not shown) for managing content, target market segment information associated with contents, and one or more URLs and/or consumer identifiers in an internal database (not shown).

Receiving module 202 may receive the consumer information from consumer database 108. Receiving module 202 may also receive additional consumer information, the consumer browsing data and/or purchase history data from third-party sources 106. For example, the consumer browsing data may include the consumer's browsing pattern, the consumer's purchase history, the consumer's favorites, the consumer's preferences and the like. Analysis module 204 may analyze the consumer information, the consumer browsing data and/or purchase history data to determine one or more targeted market segments of consumers that the consumer can be associated with. For example, analysis module 204 analyzes a consumer's browsing information which may include frequent flight ticket booking, hotel booking, etc. Based on the analysis, analysis module 204 may determine that the consumer should be associated with a frequent flier targeted market segment.

Analysis module 204 may include a set of targeted market segments. Each of the targeted market segments may be defined and may include a list of keywords and/or tags. Based on analysis of keywords, tags and/or patterns in browsing data and/or purchase history data, analysis module 204 may determine one or more targeted market segments of consumers that the consumer can be associated with. For example, association may be performed (e.g., by association module 206) by tagging the consumer information with one or more targeted market segments. Although one technique of association is described herein, other techniques of association are contemplated herein without departing from the spirit and scope of the disclosure. Moreover, in an embodiment, a consumer may not be associated with a targeted market segment, but served real time email content nonetheless.

Association module 206 may further assign one or more consumer identifiers (e.g., image URLs and/or one or more hyperlink URLs) to a consumer based on the one or more targeted market segments associated with the consumer. As described above, a consumer identifier, including the unique image URL and/or the unique hyperlink URL (as opposed to the image and/or hyperlink URLs assigned to the consumer based on the targeted market segments), may uniquely identify the consumer and/or the one or more targeted market segments associated with the consumer. Any of a consumer identifier, unique image URL, the unique hyperlink URL, image URL, hyperlink URL, consumer information and/or corresponding targeted market segments may be stored in an internal database (not shown) of content module 110. The internal database may maintain a table comprising the consumer identifier, the unique image URL, the unique hyperlink URL, the image URL, the hyperlink URL, the consumer's information and/or the one or more targeted market segments associated with the consumer.

The consumer identifier (e.g., unique image URL and/or the unique hyperlink URL) may be embedded in an email and communicated to the consumer. In one example implementation, communication module 212 may communicate the email to the consumer through server 112. Each email may include content (i.e., real time email content) corresponding to the target market segment. Also, the email may include a static content section and at least one real time email content section. Static content may include data that may be associated with an offer to the consumer. A real time email content section may include a consumer identifier, such as the consumer's unique image URL and the unique hyperlink URL, through which the real time email content is provided. In an embodiment, a unique image URL and/or any other consumer identifier may be used as place holder for real time email content (e.g., an image URL associated with the consumer) that is served to the consumer. Likewise, a unique hyperlink URL and/or any other consumer identifier may be used as a place holder for a hyperlink URL to link the consumer to a webpage associated with the content.

Receiving module 202 may receive content from content provider 102. In one embodiment, receiving module 202 may receive a consumer identifier (such as a unique hyperlink URL and/or a unique image URL), and/or, target market segment information from content database 104. For example, receiving module 202 may receive content through an interface (not shown). Such an interface may comprise a webpage comprising options to upload the content, provide links, provide targeted market segments associated with the content, and the like. Association module 206 may store the content along with target market segment information and one or more URLs associated with content in a database in a web friendly format. Where receiving module 202 only receives a unique hyperlink URL and/or a unique image URL, analysis module 204 may analyze content from content database 104 to determine possible targeted market segments that the content can be associated with. Further, association module 206 may associate the contents to the targeted market segments. Receiving module 202 may receive content at any time (e.g., before, after, or during the transmission of email to consumers).

Receiving module 202 may receive a query from an email client (e.g., a web client) associated with a consumer. The query may include a consumer identifier such as a unique image URL and/or a unique hyperlink URL associated with the consumer. In response to the query, communication module 212 may communicate content as real time email content to the email address of the consumer. For example, communication module 212 may communicate an image URL to the real time email content section of the email that replaces the unique image URL. Similarly, communication module 212 may also replace the unique hyperlink URL with the hyperlink URL to link the consumer to a webpage associated with the real time email content. In an embodiment, the consumer's unique image URL and/or unique hyperlink URL may be replaced by the hyperlink URL itself and/or the image URL itself. The term “replace” in context of image URL may refer to replacement of the link with a real time email content such as image, video, and/or multimedia data, having the image URL (linking to corresponding source). Thus, when content in content module 110, content database 104 or content provider 102 server is changed, the real time email content in the email may be changed automatically. The image, video, and/or multimedia data that are placed in real time content section may have the offer information and other information. Although, communication of content in real time is discussed, other data such as one or more offers, advertisements, and the like, may be communicated based on the consumer and the one or more targeted market segments associated with the consumer.

Communication module 212 may communicate updated content to the communicated email. Communication module 212 may communicate updated content before, during, or after a consumer opens an email.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

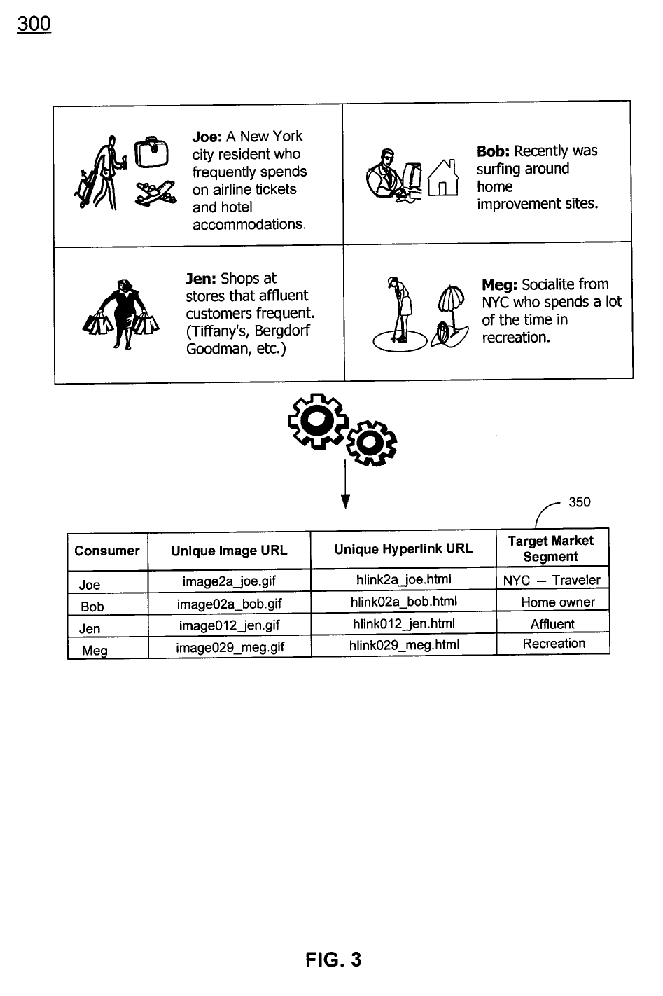

FIG. 3 shows an exemplary process 300 for associating consumers with appropriate targeted market segments. For example, receiving module 202 may receive information of four consumers from consumer database 108. Also, receiving module 202 may receive consumer information, browsing data and/or purchase data of the four consumers from third-party sources 106. The four consumers may include Joe, Bob, Jen and Meg.

Browsing data and/or purchase data associated with Joe may indicate that Joe is a New York City resident who frequently spends on airline tickets and hotel accommodations. Analysis module 204 analyses the browsing data and purchase history data of Joe and determines that Joe may be associated with “New York City—Traveler” (NYC—Traveler) group. Based on analysis, association module 206 may associate Joe to the NYC—Traveler group. Similarly, browsing data associated with Bob may indicate that Bob was surfing home improvement sites. Analysis module 204 analyses the browsing data of Bob and determines that Bob may be associated with “Home owner” group. Based on analysis, association module 206 associates Bob to the Home owner group.

Analysis module 204 may analyze the browsing data and/or purchase history data of Jen and may determine that Jen often shops at stores where affluent consumers shop. Browsing data and/or shopping data associated with Jen may indicate that Jen shopped at Tiffany's, Bergdorf, or a similar luxury store. Analysis module 204 may determine that Jen may be associated with an “Affluent” group. Based on analysis, association module 206 may associate Jen to the Affluent group. Similarly, based on analysis of browsing data and/or purchase history data of Meg, analysis module 204 may determine that that Meg may be associated with a “recreation group”. Based on analysis, association module 206 associates Meg to the recreation group.

Association module 206 may assign a consumer identifier such as a unique image URL and/or unique hyperlink URL to each consumer based on the analysis, consumer information, and/or a target market segment corresponding to each consumer. For example, Joe may be assigned a unique image URL “image2a_joe.gif” and/or a unique hyperlink URL “hlink2a_joe.html”. Similarly, Bob may be assigned a unique image URL “image02a_bob.gif” and/or a unique hyperlink URL “hlink02a_bob.html”. Jen may be assigned a unique image URL “image012_jen.gif” and/or a unique hyperlink URL “hlink012_jen.html,” and Meg may be assigned a unique image URL “image029_meg.gif” and/or a unique hyperlink URL “hlink029_meg.html”. Content module 110 may maintain a table having consumer information, unique image URLs, unique hyperlink URLs, image URLs, hyperlink URLs, and/or target segment group associated with each consumer in the internal database. An example of such a table 350 is illustrated in FIG. 3.

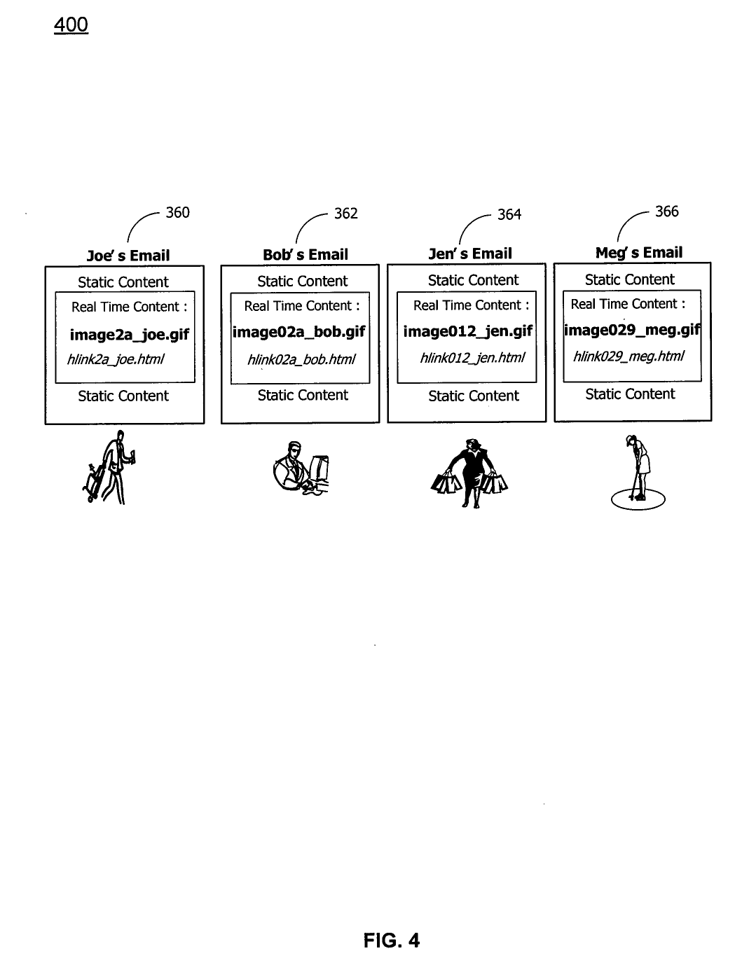

Association module 204 may create an email for each consumer in each of the targeted market segments. Each email may include a static content section and a real time content section. Static content may include data that may describe an offer to consumer. Real time content section may include a unique image URL and unique hyperlink URL. A consumer identifier (e.g., the unique image URL and the unique hyperlink URL) may be uniquely associated with the consumer and the one or more targeted market segments associated with the consumer. Communication module 212 may communicate the created emails to consumers as appropriate. An example of emails communicated to each of the consumers is illustrated in FIG. 4.

As illustrated in FIG. 4, an email 360 communicated to Joe may include a static content section and a real time content section. The real time section may include a unique URL “image2a joe.gif” and a unique hyperlink URL “hlink2a_joe.html” uniquely associated with Joe. Similarly, a real time section of an email 362 may include a unique URL “image02a_bob.gif” and a unique hyperlink URL “hlink02a_bob.html” uniquely associated with Bob. Similarly, a real time section of an email 364 may include a unique URL “image012_jen.gif” and a unique hyperlink URL “hlink012_jen.html” uniquely associated with Jen. Similarly, a real time section of an email 366 may include a unique image URL “image029_meg.gif” and a unique hyperlink URL “hlink029_meg.html” uniquely associated with Meg.

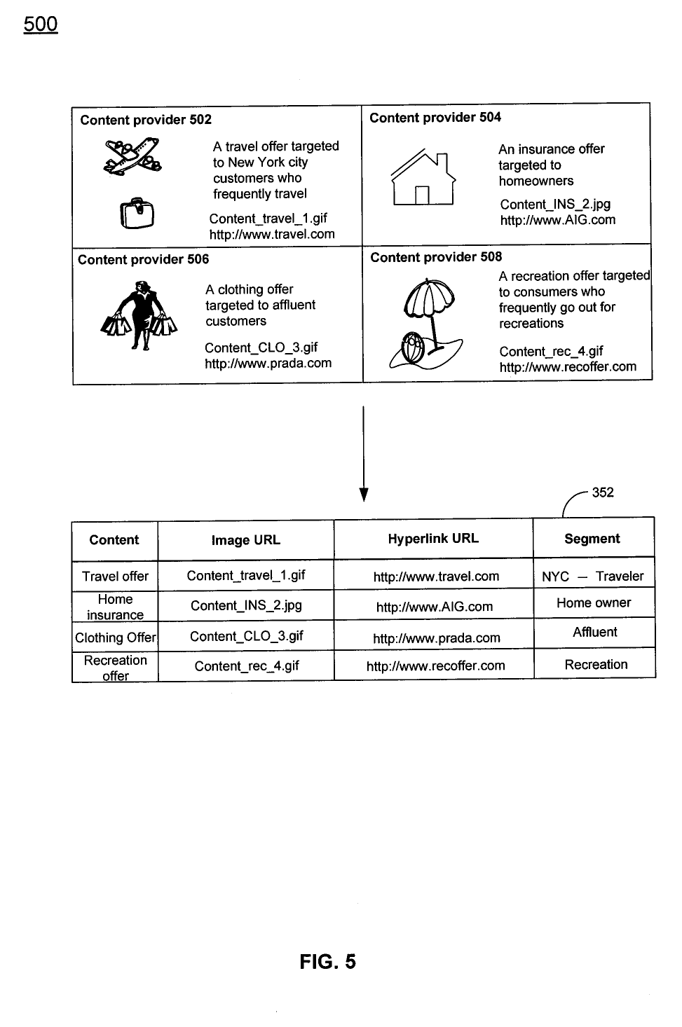

FIG. 5 illustrates a process 500 for receiving content data. Four content providers 502, 504, 506, and 508 are shown for illustrative purposes. Content provider 502 may provide content having travel related offers targeting New York City travelers. Content provider 504 may provide content having property insurance related offers targeting house owners. Content provider 506 may provide content having clothing offers targeting affluent consumers, and content provider 508 may provide content having recreation related offers targeting consumers who frequently go out for recreations.

Receiving module 202 may receive content comprising travel offers from content provider 502 along with an image URL “Content_travel_{—}1.gif”, a hyperlink URL “http://www.travel.com” and information to associate offers to the NYC-traveler segment. Similarly, receiving module 202 may receive real time email content comprising home insurance offers from content provider 504 along with an image URL “Content_INS_{—}2.gif”, a hyperlink URL “http://www.AIG.com”, and an information to associate offers to the home owner segment. Receiving module 202 may also receive content data comprising clothing offers from content provider 506 along with an image URL “Content_CLO_{—}3.gif”, a hyperlink URL “http://www.prada.com”, and an information to associate offers to the Affluent segment. Similarly, receiving module 202 may receive content data comprising recreation offers from content provider 508 along with an image URL “Content_rec_{—}4.gif”, a hyperlink URL “http://www.recoffer.com”, and an information to associate offers to the recreation segment. The information to associate offers to corresponding target segments may be obtained by content providers through structured input forms. A content management tool of content module 110 may associate the aforementioned offer contents and URLs with the one or more targeted market segments provided by the content providers and store them in the internal database. In one example, the internal database may manage content and URLs with corresponding targeted market segments in a table. An example of such table a 352 is illustrated in FIG. 5.

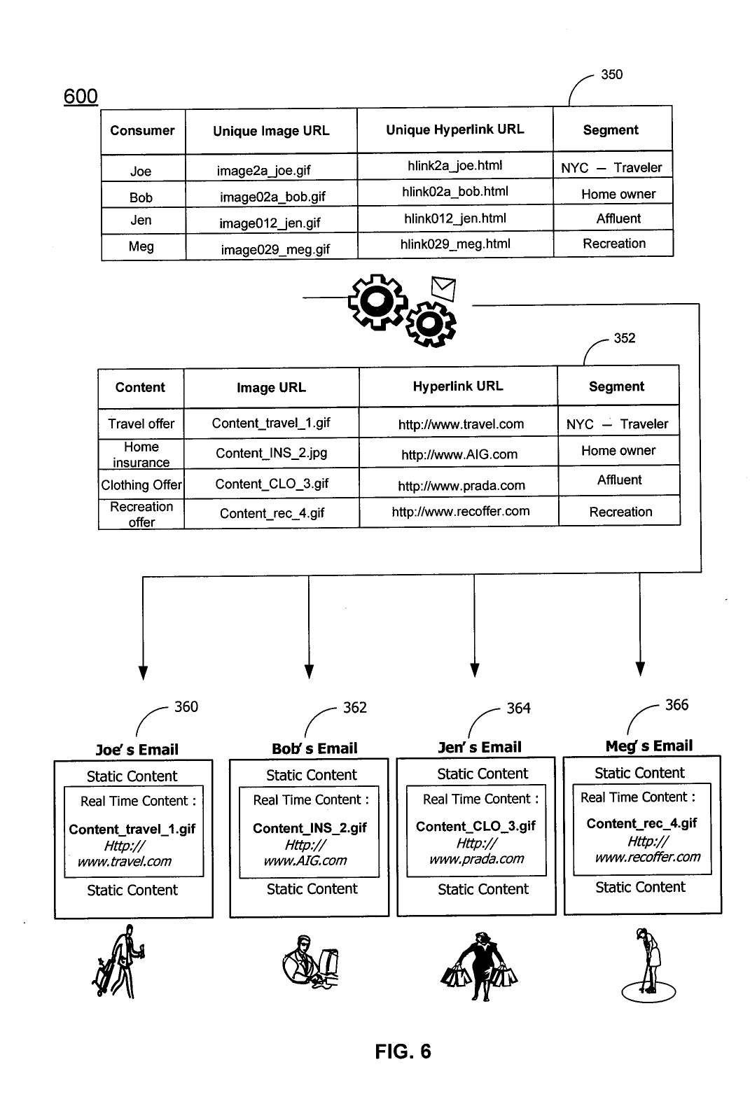

FIG. 6 shows an exemplary process 600 illustrating a step of serving real time email content to the emails 360, 362, 364, and 366. In response to a consumer opening an email, the consumer's email client may communicate one or more queries. The queries may include a consumer identifier (e.g., a unique image URL and a unique hyperlink URL). Analysis module 204 may, on identification of the consumer based on the consumer identifier, communicate an image URL and a hyperlink URL associated with one or more targeted market segments associated with the consumer. Analysis module 204 may further communicate an image URL and a hyperlink URL to a consumer based on criteria other than a targeted market segment associated with the consumer (e.g., demographic information, a request by the consumer to receive real time email content, etc.) and/or based on no criteria whatsoever (e.g., at random). Where the consumer identifier comprises a unique image URL, this may be replaced by the image URL. Likewise, the unique hyperlink URL may be replaced by the hyperlink URL.

With further regard to Joe's email 360 (for purposes of illustration), the unique image URL “image2a joe.gif” and the unique hyperlink URL “hlink2a joe.html” may be replaced by the image URL “Content_travel_{—}1.gif” and the hyperlink URL “Http://www.travel.com” respectively. Similarly, the real time content email section of the consumer Bob's email 362 comprising the unique image URL “image02a_bob.gif” and the unique hyperlink “hlink02a_bob.html” may be replaced by the image URL “Content_INS_{—}2.gif” and the hyperlink URL “Http://www.AIG.com” respectively. Similarly, the real time content email section of consumer Jen's email 364 comprising the unique image URL “image012_jen.gif” and the unique hyperlink “hlink012_jen.html” may be replaced by the image URL “Content_CLO_{—}3.gif” and the hyperlink URL “Http://www.prada.com” respectively. Similarly, the real time email content section of the consumer Meg's email 366 comprising the unique image URL “image029_meg.gif” and the unique hyperlink “hlink029_meg.html” may be replaced by the image URL “Content_rec_{—}2.gif” and the hyperlink URL “Http://www.recoffer.com” respectively. In other words, the unique image URLs may be replaced with images, video, multimedia data, and the like, having the image URL. These images, video, multimedia data, and the like may have offer information in presentation. The hyperlink URLs may navigate the consumer to a webpage associated with the (real time) email content.

The real time content in each of the emails may include one or more offers associated with targeted market segments of the consumer. Also, each of the one or more offers may be based on browsing history and/or purchasing history corresponding to the consumer. Communication module 212 may communicate content that is relevant (i.e., not expired, based on current browsing/purchasing history, etc.) at the time a consumer opens an email. For example, communication module 212 may communicate travel related offers as a real time email content to Joe, home insurance related offers as a real time email content to Bob, clothing related offers as a real time email content to Jen, and recreation offers as a real time email content to Meg.

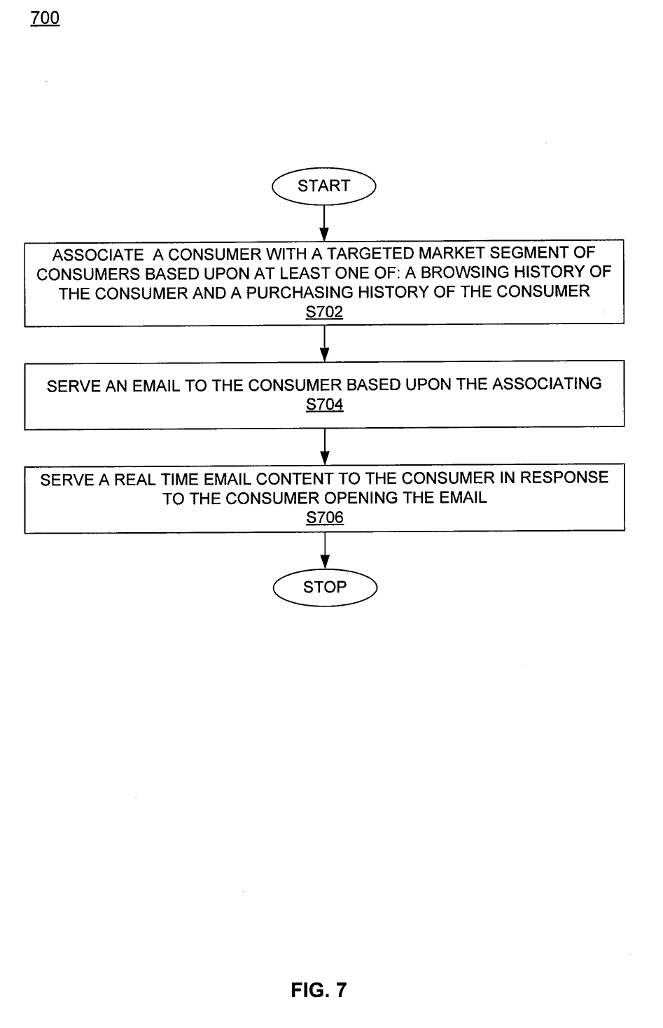

FIG. 7 is a flow chart 700 illustrating one example process of communicating real time email time content to a consumer in response to the consumer opening an email. For example, a computer-based system (e.g., content module 110) may associate a consumer with a targeted market segment of consumers based upon at least one of a browsing history of the consumer and a purchasing history of the consumer. The computer-based system may further analyze the browsing history and purchasing history of the consumer to determine consumer needs, preferences, etc. Based on this analysis, the computer-based system may associate the consumer with one or more appropriate targeted market segments (step 702). The computer-based system may additionally serve an email to the consumer (step 704). The email may be served based upon or unrelated to and in response to or irrespective of the associating. The email may comprise content based on a targeted market segment associated with the consumer. The email may include a static content section and a real time email content section.

The computer-based system may serve real time email content in response to the consumer opening the email (step 706). The computer-based system may serve the real time email content in response to a query from an email client associated with the consumer when the consumer opens the email. The query may include a consumer identifier, such as a unique image URL and/or a unique hyperlink associated with the consumer. In response to receiving the query, the computer-based system may retrieve an image URL and/or a hyperlink URL associated with the real time email content for the consumer based upon the consumer identifier. The computer-based system may receive the real time email content from content provider 102 for the targeted market segment of consumers. Further, the computer-based system may transmit the real time email content to the consumer through the consumer's email client. The real time email content may include an image URL and a hyperlink URL. The image URL may be associated with the real time email content and may be transmitted to replace a consumer identifier, like a unique image URL. Similarly, the hyperlink URL may take the place of the unique hyperlink URL in the real time content section of the email.

The computer-based system may also receive an updated real time email content for the targeted market segment of consumers from content provider 102. In one example, the computer-based system may receive the updated real time email content after the serving the email and before the consumer opens the email. In such a case, content module 110 may serve the updated real time email content instead of the real time email content.

The present disclosure (i.e., Content module 110, process 700, any part(s) or function(s) thereof) may be implemented using hardware, software or a combination thereof, and may be implemented in one or more computer systems or other processing systems. However, the manipulations performed by the present invention were often referred to in terms, such as comparing or checking, which are commonly associated with mental operations performed by a human operator. No such capability of a human operator is necessary, or desirable in most cases, in any of the operations described herein, which form a part of the system. Rather, the operations are machine operations. Useful machines for performing the operations in the system may include general-purpose digital computers or similar devices.

In fact, in accordance with an embodiment of the present system, the present system is directed towards one or more computer systems capable of carrying out the functionality described herein.

The computer system 800 may include at least one processor, such as a processor 802. Processor 802 may be connected to a communication infrastructure 804, for example, a communications bus, a cross over bar, a network, and the like. Various software embodiments are described in terms of this exemplary computer system 800. After reading this description, it will become apparent to a person skilled in the relevant art(s) how to implement the system using other computer systems and/or architectures.

The computer system 800 may include a display interface 806 that forwards graphics, text, and other data from the communication infrastructure 804 for display on a display unit 808.

The computer system 800 may further include a main memory 810, such as random access memory (RAM), and may also include a secondary memory 812. The secondary memory 812 may further include, for example, a hard disk drive 814 and/or a removable storage drive 816, representing a floppy disk drive, a magnetic tape drive, an optical disk drive, etc. The removable storage drive 816 may read from and/or write to a removable storage unit 818 in a well known manner. The removable storage unit 818 may represent a floppy disk, magnetic tape or an optical disk, and may be read by and written to by the removable storage drive 816. As will be appreciated, the removable storage unit 818 includes a computer usable storage medium having stored therein, computer software and/or data.

In accordance with various embodiments of the system, the secondary memory 812 may include other similar devices for allowing computer programs or other instructions to be loaded into the computer system 800. Such devices may include, for example, a removable storage unit 820, and an interface 822. Examples of such may include a program cartridge and cartridge interface (such as that found in video game devices), a removable memory chip (such as an erasable programmable read only memory (EPROM), or programmable read only memory (PROM)) and associated socket, and other removable storage units 820 and interfaces 822, which allow software and data to be transferred from the removable storage unit 820 to the computer system 800.

The computer system 800 may further include a communication interface 824. The communication interface 824 may allow software and data to be transferred between the computer system 800 and external devices. Examples of the communication interface 824 include, but may not be limited to a modem, a network interface (such as an Ethernet card), a communications port, a Personal Computer Memory Card International Association (PCMCIA) slot and card, and the like. Software and data transferred via the communication interface 824 are in the form of a plurality of signals, hereinafter referred to as signals 826, which may be electronic, electromagnetic, optical or other signals capable of being received by the communication interface 824. The signals 826 are provided to the communication interface 824 via a communication path (e.g., channel) 828. The communication path 828 carries the signals 826 and may be implemented using wire or cable, fiber optics, a telephone line, a cellular link, a radio frequency (RF) link and other communication channels.

In this document, the terms “computer program medium” and “computer usable medium” are used to generally refer to media such as the removable storage drive 816, a hard disk installed in hard disk drive 814, the signals 826, and the like. These computer program products provide software to the computer system 800. The disclosure is directed to such computer program products.

Computer programs (also referred to as computer control logic) may be stored in the main memory 810 and/or the secondary memory 812. Computer programs may also be received via the communication interface 804. Such computer programs, when executed, enable the computer system 800 to perform the features of the present invention, as discussed herein. In particular, the computer programs, when executed, enable the processor 802 to perform the features of the present invention. Accordingly, such computer programs represent controllers of the computer system 800.

In accordance with an embodiment, where the system is implemented using a software, the software may be stored in a computer program product and loaded into the computer system 800 using the removable storage drive 816, the hard disk drive 814 or the communication interface 824. The control logic (software), when executed by the processor 802, causes the processor 802 to perform the functions of the system as described herein.

In another embodiment, the system may be implemented primarily in hardware using, for example, hardware components such as application specific integrated circuits (ASIC). Implementation of the hardware state machine so as to perform the functions described herein will be apparent to persons skilled in the relevant art(s).

In yet another embodiment, the system is implemented using a combination of both the hardware and the software.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures illustrated in the attachments, which highlight the functionality and advantages of the present invention, are presented for example purposes only. The architecture of the system is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

Systems, methods and computer program products are provided. In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in alternative embodiments.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The present disclosure is described herein with reference to block diagrams and flowchart illustrations of methods, and computer program products according to various aspects of the invention. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flow diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, websites, web forms, prompts, etc. Practitioners will appreciate that the illustrated steps described herein may comprise in any number of configurations including the use of windows, web pages, hypertexts, hyperlinks, web forms, popup windows, prompts and the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” should be construed to exclude only those types of transitory computer-readable media which were found in In Re Nuitjten to fall outside the scope of patentable subject matter under 35 U.S.C. § 101.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the disclosure. It should be understood that the detailed description and specific examples, indicating exemplary embodiments of the system, are given for purposes of illustration only and not as limitations. Many changes and modifications within the scope of the instant invention may be made without departing from the spirit thereof, and the disclosure includes all such modifications. Corresponding structures, materials, acts, and equivalents of all elements in the claims below are intended to include any structure, material, or acts for performing the functions in combination with other claim elements as specifically claimed. The scope of the invention should be determined by the appended claims and their legal equivalents, rather than by the examples given above. Reference to an element in the singular is not intended to mean “one and only one” unless explicitly so stated, but rather “one or more.” Moreover, where a phrase similar to at least one of A, B, and C is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

1. A method comprising:
associating, by a computer-based system for serving real time email content, a consumer with a targeted market segment of consumers based upon at least one of: a browsing history of the consumer and a purchasing history of the consumer;
serving, by the computer-based system, an email to the consumer based upon the associating; and
serving, by the computer-based system, real time email content to the consumer in response to the consumer opening the email.

2. The method of claim 1, further comprising receiving, by the computer-based system, a query from an email client associated with the consumer in response to the consumer opening the email, wherein the query includes a unique image uniform resource locator (“URL”) associated with the consumer.

3. The method of claim 1, further comprising retrieving, by the computer-based system, the real time email content for the consumer based upon a unique image uniform resource locator (“URL”) that identifies the consumer.

4. The method of claim 1, further comprising transmitting, by the computer-based system and to an email client associated with the consumer, an image uniform resource locator (“URL”) associated with the real time email content to replace a unique image URL that identifies the consumer.

5. The method of claim 1, further comprising receiving, by the computer-based system, a query from an email client associated with the consumer in response to the consumer opening the email, wherein the query includes a unique hyperlink uniform resource locator (“URL”) associated with the consumer.

6. The method of claim 1, further comprising retrieving, by the computer-based system, a hyperlink associated with the real time email content based upon a unique image uniform resource locator (“URL”) that identifies the consumer.

7. The method of claim 1, further comprising transmitting, by the computer-based system and to an email client associated with the consumer, a hyperlink uniform resource locator (“URL”) associated with the real time email content, wherein the hyperlink URL links to a webpage associated with the real time email content.

8. The method of claim 1, further comprising receiving, by the computer-based system and from a content provider, updated real time email content for the targeted market segment of consumers.

9. The method of claim 8, wherein the updated real time email content is received by the computer-based system after the serving the email and before the consumer opens the email.

10. The method of claim 9, further comprising serving, by the computer-based system, the updated real time email content instead of the real time email content.

11. The method of claim 1, further comprising receiving, by the computer-based system and from a marketer, the real time email content for the targeted market segment of consumers, and storing, by the computer-based system, the real time email content.

12. An article of manufacture including a non-transitory, tangible computer readable medium having instructions stored thereon that, in response to execution by a computer-based system for serving real time email content, cause the computer-based system to perform operations comprising:
associating, by the computer-based system, a consumer with a targeted market segment of consumers based upon at least one of: a browsing history of the consumer and a purchasing history of the consumer;
serving, by the computer-based system, an email to the consumer based upon the associating; and
serving, by the computer-based system, the real time email content to the consumer in response to the consumer opening the email.

13. The article of claim 12, further comprising receiving, by the computer-based system, a query from an email client associated with the consumer in response to the consumer opening the email, wherein the query includes a unique image uniform resource locator (“URL”) associated with the consumer.

14. The article of claim 12, further comprising retrieving, by the computer-based system, the real time email content for the consumer based upon a unique image uniform resource locator (“URL”) that identifies the consumer.

15. The article of claim 12, further comprising transmitting, by the computer-based system and to an email client associated with the consumer, an image uniform resource locator (“URL”) associated with the real time email content to replace a unique image URL that identifies the consumer.

16. The article of claim 12, further comprising receiving, by the computer-based system and from a content provider, updated real time email content for the targeted market segment of consumers.

17. A system comprising:
a processor for serving real time email content,
a tangible, non-transitory memory configured to communicate with the processor,
the tangible, non-transitory memory having instructions stored thereon that, in response to execution by the processor, cause the processor to perform operations comprising:
associating, by the processor, a consumer with a targeted market segment of consumers based upon at least one of: a browsing history of the consumer and a purchasing history of the consumer;
serving, by the processor, an email to the consumer based upon the associating; and
serving, by the processor, the real time email content to the consumer in response to the consumer opening the email.

18. The system of claim 17, further comprising receiving, by the processor a query from an email client associated with the consumer in response to the consumer opening the email, wherein the query includes a unique image uniform resource locator (“URL”) associated with the consumer.

19. The system of claim 17, further comprising retrieving, by the processor, the real time email content for the consumer based upon a unique image uniform resource locator (“URL”) that identifies the consumer.

20. The system of claim 17, further comprising transmitting, by the processor and to an email client associated with the consumer, an image uniform resource locator (“URL”) associated with the real time email content to replace a unique image URL that identifies the consumer.

21. The system of claim 17, further comprising receiving, by the processor and from a content provider, updated real time email content for the targeted market segment of consumers.
